(19) United States
(12) Patent Application Publication
(10) Pub. No.: US 2023/0252531 A1
(43) Pub. Date: Aug. 10, 2023

(54) METHOD AND APPARATUS FOR PROVIDING USED ARTICLE TRADING SERVICE USING SMART BOX

(71) Applicant: ACL Co.,Ltd., Incheon (KR)

(72) Inventor: Hwang Geun BAE, Incheon (KR)

(73) Assignee: ACL Co.,Ltd., Incheon (KR)

(21) Appl. No.: 17/724,517

(22) Filed: Apr. 20, 2022

(30) Foreign Application Priority Data
Feb. 10, 2022 (KR) 10-2022-0017828

(51) Int. Cl. G06Q 30/02

(52) U.S. Cl. CPC G06Q 30/0278; G06Q 30/0283

(57) ABSTRACT

A method for providing an used article trading service using a smart box according to one embodiment of the present invention includes: receiving article information from a user terminal; calculating an article score; calculating a price; providing price information to the user terminal; receiving first selection information about a selling scheme from the user terminal; transmitting a notification instructing the user to deposit the selling price to the administrator terminal; and receiving confirmation information indicating that the selling price is deposited from the user terminal.

### CROSS-REFERENCE TO RELATED APPLICATION

This application claims priority under 35 USC § 119 to Korean Patent Application No. 10-2022-0017828 filed on Feb. 10, 2022 in the Korean Intellectual Property Office (KIPO), the entire disclosure of which is incorporated herein by reference.

### BACKGROUND OF THE INVENTION

### 1. Field of the Invention

The present invention relates to a method and an apparatus for providing a used article trading service using a smart box.

### 2. Description of the Related Art

The content described below merely provides background information related to the embodiment according to the present invention and does not constitute the prior art.

As the online second-hand market grows in size, transactions based on C2C, as well as B2C having been the basis of e-commerce, are rapidly growing. The second-hand market has been gradually globalized and enlarged with the development of information technology, and accordingly expected to have an important socio-economic impact. However, due to the incomplete system of the recent second-hand transaction, complex problems including fraud cases are continuously occurring. The safe transaction system applied in the second-hand transaction platform can solve the Internet fraud problem to some extent, however, the actual utilization rate is significantly low due to the high commission rate. Accordingly, the second-hand transaction platform actually remains at the level of providing an online space in which consumers and sellers can check information with each other. Transactions are carried out depending on mutual trust in the counter party, but the mutual trust is not easily achieved. Thus, in many cases, transacting parties only make limited transactions or use transaction schemes that incur high transaction costs.

### SUMMARY OF THE INVENTION

The present invention provides a used article trading service using a smart box.

In addition, the present invention further provides a non-face-to-face used article trading service between buyers and sellers.

In addition, the present invention further provides a used article trading service in which users decide a selling price and a selling period.

The method for providing a used article trading service using a smart box according to one embodiment of the present invention for achieving the above objects includes: receiving, from a user terminal, article information about a used article put, by a user, in the smart box to sell the used article; calculating an article score for performance and appearance states of the used article, based on the article information; calculating a price of the used article corresponding to a selling scheme including an immediate selling and a consignment selling, based on the article score; providing price information including the calculated price to the user terminal; receiving first selection information about the selling schemes from the user terminal; transmitting a notification, which instructs the user to deposit a selling price corresponding to the first selection information, to an administrator terminal; and receiving first confirmation information, which indicates that the selling price corresponding to the first selection information is deposited, from the user terminal.

In addition, the apparatus for providing a used article trading service using a smart box according to one embodiment of the present invention includes a memory recording at least one program and a processor executing the program, and the program includes instructions for executing: receiving, from a user terminal, article information about a used article put, by a user, in the smart box to sell the used article; calculating an article score for performance and appearance states of the used article, based on the article information; calculating a price of the used article corresponding to a selling scheme including an immediate selling and a consignment selling, based on the article score; providing price information including the calculated price to the user terminal; receiving first selection information about the selling schemes from the user terminal; transmitting a notification, which instructs the user to deposit a selling price corresponding to the first selection information, to an administrator terminal; and receiving first confirmation information, which indicates that the selling price corresponding to the first selection information is deposited, from the user terminal.

The present invention can provide a used article trading service using a smart box.

In addition, the present invention can provide a used article trading service that cab calculate an appropriate selling price, by complementing a difference between article information inputted by the user and actual article information.

In addition, the present invention can provide a non-face-to-face used article trading service between a buyer and a seller.

In addition, the present invention can provide a used article trading service in which a user determines a selling price and a selling period.

### BRIEF DESCRIPTION OF THE DRAWINGS

FIG. 1 is a block diagram showing the entities for providing a used article trading service using a smart box according to one embodiment of the present invention.

FIG. 2 is an operation flowchart showing the method for providing a used article trading service using a smart box according to one embodiment of the present invention.

FIG. 3 is an operation flowchart showing the method for providing a used article trading service using a smart box according to one embodiment of the present invention.

FIG. 4 is an operation flowchart showing the method for providing a used article trading service using a smart box according to one embodiment of the present invention.

FIG. 5 is an operation flowchart showing the method for providing a used article trading service using a smart box according to one embodiment of the present invention.

FIG. 6 is an operation flowchart showing the method for providing a used article trading service using a smart box according to one embodiment of the present invention.

FIG. 7 is an operation flowchart showing the method for providing a used article trading service using a smart box according to one embodiment of the present invention.

FIG. 8 is an operation flowchart showing the method for providing a used article trading service using a smart box according to one embodiment of the present invention.

FIG. 9 is a view showing a computer system according to one embodiment of the present invention.

### DETAILED DESCRIPTION OF THE INVENTION

The present invention will be described in detail with reference to the accompanying drawings as follows. Herein, repeated descriptions and detailed descriptions for known functions and configurations that may unnecessarily obscure the essentials of the invention will be omitted. The embodiments of the present invention are provided in order to more completely describe the present invention to those having ordinary skill in the art. Accordingly, the shapes and sizes of elements in the drawings may be exaggerated for clearer description.

Throughout the specification, when a part “includes” a certain component, the above expression does not exclude other elements, but may further include the other elements, unless particularly stated otherwise.

Hereinafter, exemplary embodiments according to the present invention will be described in detail with reference to the accompanying drawings.

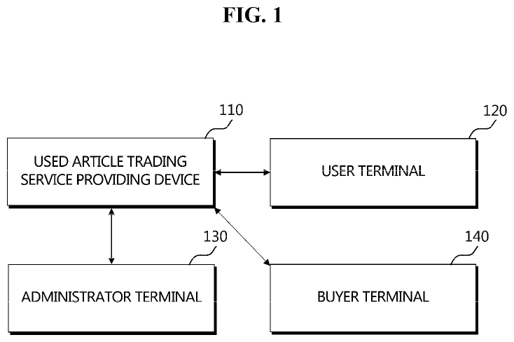

FIG. 1 is a block diagram showing the entities for providing a used article trading service using a smart box according to one embodiment of the present invention.

Referring to FIG. 1, the entity for providing the used article trading service using a smart box according to one embodiment of the present invention includes a used article trading service providing device 110, a user terminal 120, an administrator terminal 130, and a buyer terminal 140.

The used article trading service providing device 110 may refer to a device for receiving article information about a used article, which a user wants to sell, from the user terminal 120, and calculating a price of the used article.

The used article trading service providing device 110 may refer to a device for receiving selection information about a selling scheme from the user terminal 120, and transmitting a notification, which instructs to deposit a selling price corresponding to the selection information, to the administrator terminal 130.

The used article trading service providing device 110 may refer to a device for receiving a purchase request from the buyer terminal 140 and transmitting a notification to the buyer terminal 140.

The used article trading service providing device 110 may refer to a device for receiving user information from the user terminal 120 and generating member information.

The used article trading service providing device 110 may refer to a device for receiving confirmation information indicating that the selling price is deposited from the user terminal 120.

The user terminal 120 may refer to a device for providing article information on a used article to be sold to the used article trading service providing device 110, and receiving the selling price for the used article.

The user terminal 120 may refer to a device for providing selection information about the selling scheme to the used article trading service providing device 110, and providing confirmation information indicating that the selling price is deposited.

The manager terminal 130 may refer to a device for receiving a notification instructing the deposit of the selling price corresponding to the selection information from the used article trading service providing device 110.

The buyer terminal 140 may refer to a device for providing a purchase request to the used article trading service providing device 110, and receiving a notification about a used article which the buyer wants to buy.

The used article trading service providing device 110 and the user terminal 120, the used article trading service providing device 110 and the administrator terminal 130, and the used article trading service providing device 110 and the buyer terminal 140 may be connected to each other via a communication network.

The communication network refers to an access path for enabling data to be transmitted and received between the above parties. For example, the communication network may cover wired networks such as Local Area Networks (LANs), Wide Area Networks (WANs), Metropolitan Area Networks (MANs), and Integrated Service Digital Networks (ISDNs), and wireless networks such as wireless LANs, CDMA, Bluetooth, satellite communications. However, the scope of the communication network applicable to the present invention is not limited thereto.

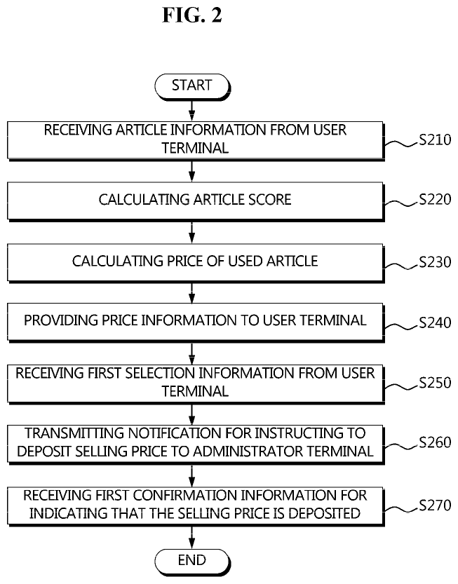

FIG. 2 is an operation flowchart showing the method for providing a used article trading service using a smart box according to one embodiment of the present invention.

Referring to FIG. 2, according to the method for providing a used article trading service using a smart box according to one embodiment of the present invention, first, the article information about the used article put by the user in the smart box for sale may be received from the user terminal (S210).

When the user wants to put the used article in the smart box, user information may be received from the user terminal and user authentication for the user may be performed.

The smart box may include a darkroom, a lighting and a plurality of small cameras to for take pictures, and may photograph the used article by using the small cameras.

Next, based on the article information, an article score for performance and appearance states of the used article may be calculated (S220).

Next, based on the article score, a price of the used article corresponding to a selling scheme including an immediate selling and a consignment selling may be calculated (S230).

The immediate selling may refer to a scheme in which the user sells the used article to the administrator of the used article trading service providing device. In addition, the consignment selling may refer to a method in which the user consigns selling the used article to the administrator, and the administrator sells the used article to a buyer wanting to buy the used article.

Next, price information including the calculated price may be provided to the user terminal (S240).

Next, first selection information about the selling schemes may be received from the user terminal (S250).

The first selection information may include a selection of the user for the selling schemes between the immediate selling and the consignment selling.

Next, a notification, which instructs the user to deposit a selling price corresponding to the first selection information, may be transmitted to the administrator terminal (S260).

Next, first confirmation information, which indicates that the selling price corresponding to the first selection information is deposited, may be received from the user terminal (S270).

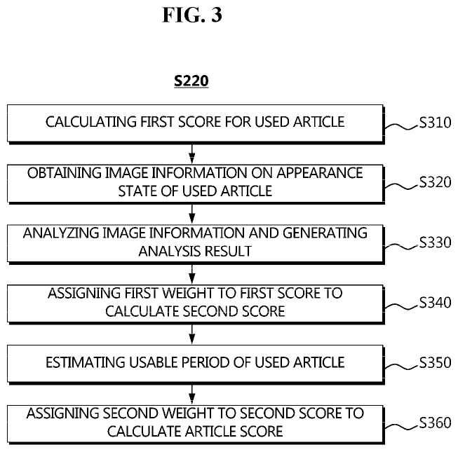

FIG. 3 is an operation flowchart showing the method for providing a used article trading service using a smart box according to one embodiment of the present invention.

Referring to FIG. 3, according to the method for providing an used article trading service using a smart box according to one embodiment of the present invention, first, a first score for the used article may be calculated based on the article information (S310).

Next, image information on the appearance state of the used article may be obtained by using the cameras installed in the smart box (S320).

Next, the image information may be analyzed and an analysis result for the appearance state of the used article may be generated based on a preset artificial intelligence algorithm (S330).

Next, based on the analysis result, a first weight may be assigned to the first score to calculate a second score (S340).

When the appearance state of the used article included in the analysis result is determined as being better than a preset reference state, the first weight may be applied to increase the first score, and when the appearance state is not better than the preset reference state, the first weight may be applied to decrease the first score, so that the second score may be calculated.

Next, the usable period of the used article may be estimated based on artificial intelligence learning data trained based on data of other users (S350).

Before step S350, usable period information on the usable period for the used articles sold by other users may be received from other user terminals.

In addition, in step S350, the artificial intelligence learning data, which is trained through the relationship between the article information of the used article sold by the other users and the usable period information, may be used, so that the usable period of the used article may be calculated based on the article information.

Next, based on the estimated result, the second weight may be assigned to the second score to calculate an article score (S360).

When the usable period is longer than an average of usable period information of used articles sold by the other users, the second weight may be applied to increase the second score, and when the usable period is shorter than the average, the second weight may be applied to decrease the second score, so that the article score may be calculated.

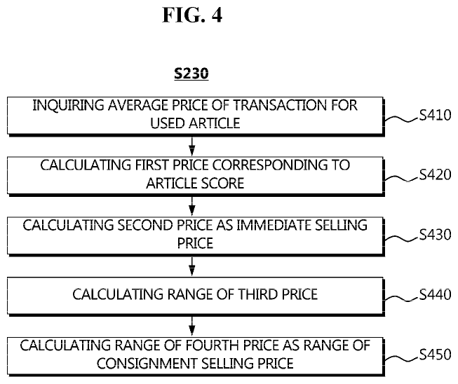

FIG. 4 is an operation flowchart showing the method for providing a used article trading service using a smart box according to one embodiment of the present invention.

Referring to FIG. 4, according to the method for providing a used article trading service using a smart box according to one embodiment of the present invention, first, an average price of transaction for the used article may be inquired (S410).

Next, a first price corresponding to the article score may be calculated based on the average price (S420).

At this point, the first price may be calculated as a price obtained by multiplying the average price by a ratio of the article score to the preset reference article score.

The preset reference article score may be replaced with the first score.

For example, when the first score is 90 points, and when the article score is calculated as 81 points, the first price may be calculated as an amount corresponding to 90% of the average price. The first score and the article score are only examples according to one embodiment, and do not limit the scope of the present invention.

Next, a second price obtained by subtracting a commission of a preset first rate from the first price may be calculated as an immediate selling price (S430).

Next, a range of a third price may be calculated by applying a range of a preset second rate to the first price (S440).

The range of the third price may range between a minimum value obtained by subtracting an amount equal to the second rate of the first price from the first price, and a maximum value obtained by adding the amount equal to the second rate of the first price to the first price.

Next, a fourth price ranging from a minimum value to a maximum value among the prices calculated by applying a commission according to a consignment selling period to the range of the third price may be calculated as the range of the consignment selling price (S450).

For example, the commission according to the consignment selling period may be set higher as the consignment selling period is longer. Accordingly, the minimum value in the range of the fourth price may be an amount obtained by subtracting the maximum commission from the minimum value in the range of the third price, and the maximum value in the range of the fourth price may be an amount obtained by subtracting an amount equal to the minimum commission from the maximum value in the range of the third price.

The minimum value in the range of the fourth price may be greater than or equal to the immediate selling price.

In step S240, the ranges of the immediate selling price and the consignment selling price may be provided to the user terminal.

According to one embodiment, the first score may refer to a score of the used article calculated based on the article information inputted by the user. The article information may be inputted incorrectly by the user, or may be inputted by the user falsely. Thus, when the price of the used article is calculated using only the first score, a wrong price may be calculated. In order to complement the above situation, the image information on the appearance state of the used article acquired using the smart box may be analyzed, and a new score may be calculated based on the analysis result, so that the appropriate selling price for the used article may be calculated.

Accordingly, the selling price acceptable to both of the user and the buyer may be calculated by compensating for the price difference that may be caused by the gap between the article information of the used article inputted by the user and the article information obtained and analyzed through the smart box.

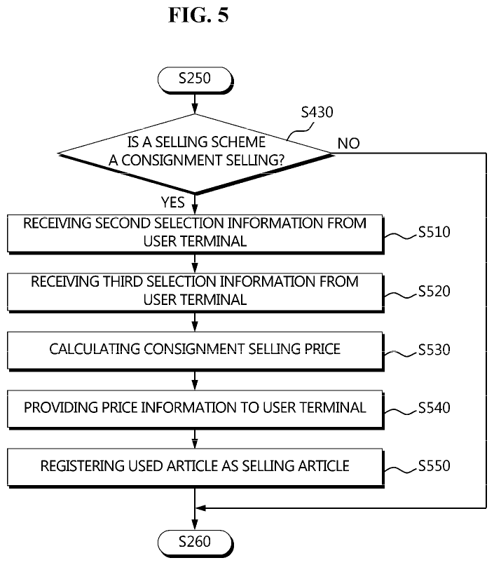

FIG. 5 is an operation flowchart showing the method for providing a used article trading service using a smart box according to another embodiment of the present invention.

Referring to FIG. 5, in the method for providing an used article trading service using a smart box according to one embodiment of the present invention, after the step of receiving the first selection information for the selling scheme, and when the above selling scheme is the consignment selling, second selection information of the user may be received within the range of the third price from the user terminal (S510).

The second selection information may include selection of an amount desired by the user within the range of the third price.

When the above selling scheme is not the consignment selling but the immediate selling, a notification, in step S260, for instructing the selling price corresponding to the immediate selling price is required to be deposited may be transmitted to the administrator terminal.

Next, third selection information of the user on the consignment selling period may be received from the user terminal (S520).

For the consignment selling period, the user may select a desired period from a preset minimum period to a maximum period.

For example, when the preset minimum period is 1 week, and the preset maximum period is 1 month, the user may select the desired period from 7 days to 30 days. The above period is only examples according to one embodiment, and does not limit the scope of the present invention.

Next, an amount obtained by subtracting a commission corresponding to the consignment selling period included in the third selection information from the price included in the second selection information may be calculated as the consignment selling price (S530).

Next, price information including the consignment selling price may be provided to the user terminal (S540).

Next, the used article may be registered as a selling article (S550).

Accordingly, the used article trading service providing device may provide the calculated price to enable the user to directly determine the price, and the user may directly determine a selling price and a selling period of the used article by determining the price and commission.

As a selective embodiment, when the consignment selling price is equal to or lower than the immediate selling price in step S530, price information including the immediate selling price may be provided to the user terminal in step S540. In addition, a notification for instructing the selling price corresponding to the immediate selling price is required to be deposited may be transmitted to the administrator terminal without registering the used article as a selling article.

As a selective embodiment, in step S250, first selection information including the user's selection for donation of an amount corresponding to the selling price of the used article may be received from the user terminal. When the user selects donation, a notification for instructing that the selling price of the used article be used for donation may be transmitted to the administrator terminal.

As a selective embodiment, after step S550, selling information on the used article may be registered in the used article trading platform by using the smart box. The used article may be photographed using the small cameras included in the smart box, and then the article information, the selling price, and the photos of the used article may be registered in the used article trading platform.

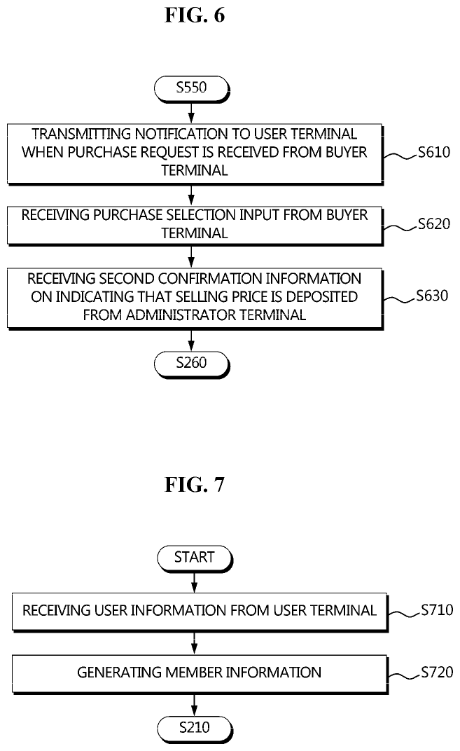

FIG. 6 is an operation flowchart showing the method for providing a used article trading service using a smart box according to one embodiment of the present invention.

Referring to FIG. 6, in the method for providing an used article trading service using a smart box according to one embodiment of the present invention, after the step of registering the used article as the selling article, and when a purchase request for the used article is received from the buyer terminal, a notification including the article information and the analysis result may be transmitted to the buyer terminal (S610).

Next, a purchase selection input of the buyer may be received from the buyer terminal (S620).

After step S620, and when the buyer wants to receive the used article from the smart box, buyer information may be received from the buyer terminal and identity authentication on the buyer may be performed.

Next, second confirmation information indicating that the selling price corresponding to the consignment selling price is deposited may be received from the administrator terminal (S630).

In step S260, when purchase confirmation information for the used article is received from the buyer terminal, a notification for instructing to deposit the selling price corresponding to the consignment selling price to the user may be transmitted to the administrator terminal.

In addition, after step S630, and when purchase cancellation information is received from the buyer terminal, a notification for instructing to refund the selling price to the buyer may be transmitted to the administrator terminal, after the used article is confirmed as being collected.

Accordingly, the used article trading service providing device can provide a used article trading service in which buyers and sellers can trade used article non-face-to-face without directly meeting each other.

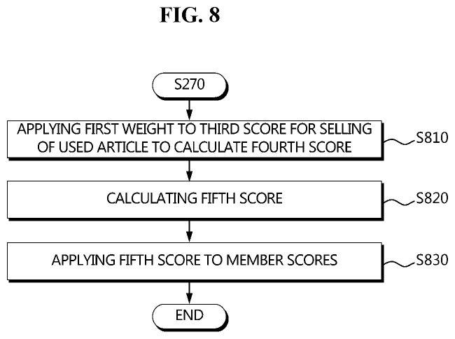

FIG. 7 is an operation flowchart showing the method for providing a used article trading service using a smart box according to one embodiment of the present invention.

Referring to FIG. 7, in the method for providing a used article trading service using a smart box according to one embodiment of the present invention, user information may be received from the user terminal before receiving the article information (S710).

Next, member information may be generated by using the user information (S720).

The member information may include a membership level, member scores, and selling counts, and the membership level may be divided according to a preset member score section.

FIG. 8 is an operation flowchart showing the method for providing a used article trading service using a smart box according to one embodiment of the present invention.

Referring to FIG. 8, in the method for providing an used article trading service using a smart box according to one embodiment of the present invention, after the first confirmation information is received, the first weight may be applied to a third score for the selling of the used article, so that a fourth score may be calculated (S810).

The third score refer to a membership score basically increased when a user sells a used article.

Next, a fifth score may be calculated by applying a preset third rate corresponding to the selling count section including the selling counts of the user among preset selling count sections to the fourth score (S820).

Next, the fifth score may be granted to the member scores (S830).

For example, a first weight, which refers to a weight according to the appearance state of the used article, may be applied to the third score, so that the fourth score may be calculated. A greater weight may be applied to the used article having a good appearance state, so as to acquire a higher score. In addition, when the selling counts are increased, the third rate may be increased, so that a higher score may be acquired.

As a selective embodiment, the smart box includes a front display. When the user does not use the smart box, an advertisement image may be reproduced through the front display. When the user touches the display to use the smart box, the playback of the advertisement image may stop and the image may be invisible to the user, and the advertisement image may be played again after the use by the user is completed and a preset time elapses.

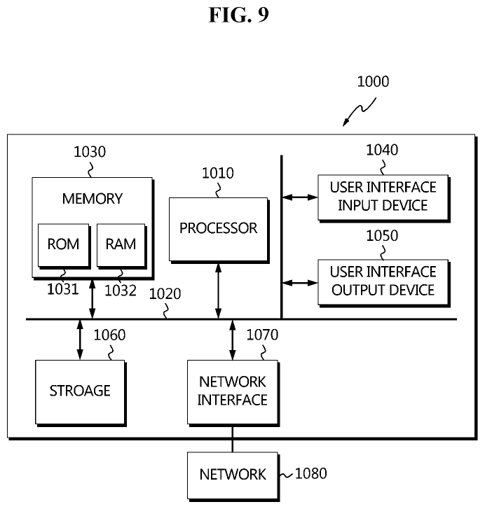

FIG. 9 is a view showing a computer system according to one embodiment of the present invention.

The apparatus for providing a used article trading service using a smart box according to one embodiment of the present invention may be implemented in a computer system 1000 such as a computer-readable recording medium.

Referring to FIG. 9, the computer system 1000 may include at least one processor 1010, memory 1030, user interface input device 1040, user interface output device 1050, and storage 1060 that communicate with each other via a bus 1020. In addition, the computer system 1000 may further include a network interface 1070 connected to network 1080. The processor 1010 may be a central processing unit or a semiconductor device that executes processing instructions stored in the memory 1030 or the storage 1060. The memory 1030 and the storage 1060 may include various forms of volatile or non-volatile storage media. For example, the memory may include ROM 1031 or RAM 1032.

The specific implementations described in the present invention merely are embodiments, and do not intended to limit the scope of the present invention in any case. For clarity of the specification, the description of conventional electronic components, control systems, software, and other functional aspects of the above systems may be omitted. In addition, the connections or connecting members of lines between the components shown in the drawings exemplify functional connections and/or physical or circuit-wise connections, and alternative or additional various functional connections, physical connections, or circuit-wise connections may be embodied in actual devices. In addition, the corresponding component may not be required for application of the present invention, unless specifically stated as “essential”, “important”, or the like.

Therefore, the spirit of the present invention will not be limited to the embodiments described above, and the claims described below and all ranges equivalent to or modified from the claims will fall within the scope of the spirit of the present invention.

What is claimed is:

1. A method for providing a used article trading service using a smart box, the method comprising:
receiving, from a user terminal, article information about a used article put, by a user, in the smart box to sell the used article;
calculating an article score for performance and appearance states of the used article, based on the article information;
calculating a price of the used article corresponding to a selling scheme including an immediate selling and a consignment selling, based on the article score;
providing price information including the calculated price to the user terminal;
receiving first selection information about the selling schemes from the user terminal;
transmitting a notification, which instructs the user to deposit a selling price corresponding to the first selection information, to an administrator terminal; and
receiving first confirmation information, which indicates that the selling price corresponding to the first selection information is deposited, from the user terminal.

2. The method of claim 1, wherein the calculating of the article score includes:
calculating a first score for the used article based on the article information;
acquiring image information on an appearance state of the used article by using the cameras installed in the smart box;
analyzing the image information and generating an analysis result for the appearance state of the used article, based on a preset artificial intelligence algorithm;
assigning a first weight to the first score and calculating a second score, based on the analysis result;
estimating a usable period of the used article based on artificial intelligence learning data trained based on data of other users; and
assigning a second weight to the second score and calculating an article score based on the estimated result.

3. The method of claim 2, wherein the calculating of the price of the used article includes:
inquiring an average price of transaction for the used article;
calculating a first price corresponding to the article score based on the average price;
calculating a second price, as an immediate selling price, obtained by subtracting a commission of a preset first rate from the first price;
calculating a range of a third price by applying a range of a preset second rate to the first price; and
calculating a fourth price ranging, as the range of the consignment selling price, from a minimum value to a maximum value among the prices calculated by applying a commission according to a consignment selling period to the range of the third price, wherein
the providing of the price information includes providing the ranges of the immediate selling price and the consignment selling price to the user terminal, and
the third price ranges between a minimum value obtained by subtracting an amount equal to the second rate of the first price from the first price, and a maximum value obtained by adding the amount equal to the second rate of the first price to the first price.

4. The method of claim 3, wherein the calculating of the second score includes:
calculating the second score by applying the first weight to increase the first score when the appearance state of the used article included in the analysis result is determined as being better than a preset reference state, and applying the first weight to decrease the first score when the appearance state is not better than the preset reference state, and
receiving usable period information on the usable period for the used articles sold by other users from other user terminals before the estimating of the usable period of the used article, wherein
the estimating of the usable period of the used article includes: calculating the usable period of the used article based on the article information by using the artificial intelligence learning data trained through the relationship between the article information of the used article sold by the other users and the usable period information,
the assigning of the second weight to the second score to calculate the article score includes: calculating the article score by applying the second weight to increase the second score when the usable period is longer than an average of usable period information of used articles sold by the other users, and applying the second weight to decrease the second score when the usable period is shorter than the average, and
the calculating of the first price corresponding to the article score includes: calculating the first price as a price obtained by multiplying the average price by a ratio of the article score to the preset reference article score.

5. The method of claim 3, wherein the transmitting a notification for instructing the deposit of the selling price includes: transmitting, when the selling scheme is the immediate selling, a notification for instructing the selling price corresponding to the immediate selling price is required to be deposited, to the administrator terminal.

6. The method claim 3, further comprising:
receiving second selection information of the user within the range of the third price from the user terminal, after the receiving of the first selection information for the selling scheme, and when the above selling scheme is the consignment selling;
receiving third selection information of the user on the consignment selling period from the user terminal;
calculating an amount, as the consignment selling price, obtained by subtracting a commission corresponding to the consignment selling period included in the third selection information from the price included in the second selection information;
providing price information including the consignment selling price to the user terminal; and
registering the used article as a selling article.

7. The method of claim 6, further comprising:
transmitting a notification including the article information and the analysis result to the buyer terminal, after the registering of the used article as the selling article, and when a purchase request for the used article is received from the buyer terminal;
receiving a purchase selection input of the buyer from the buyer terminal; and
receiving second confirmation information indicating that the selling price corresponding to the consignment selling price is deposited from the administrator terminal, wherein
the transmitting of the notification, which instructs the user to deposit the selling price corresponding to the first selection information, to the administrator terminal includes:
transmitting a notification for instructing to deposit the selling price corresponding to the consignment selling price to the user to the administrator terminal when purchase confirmation information for the used article is received from the buyer terminal, and
transmitting a notification for instructing to refund the selling price to the buyer, to the administrator terminal, after the used article is confirmed as being collected, after the receiving of the second confirmation information and when purchase cancellation information is received from the buyer terminal.

8. The method of claim 4, further comprising:
receiving user information from the user terminal before receiving the article information; and
generating member information by using the user information, wherein
the member information includes a membership level, member scores, and selling counts, in which the membership level is divided according to preset member score sections.

9. The method of claim 8, further comprising:
calculating, after the first confirmation information is received, a fourth score by applying the first weight to a third score for selling the used article;
calculating a fifth score by applying a preset third rate corresponding to the selling count section including the selling counts of the user among preset selling count sections to the fourth score; and
granting the fifth score to the member scores.

10. An apparatus for providing an used article trading service using a smart box, the apparatus comprising:
a memory in which at least one program is recorded; and
a processor for executing the program, wherein
the program includes instructions for executing:
receiving, from a user terminal, article information about a used article put, by a user, in the smart box to sell the used article;
calculating an article score for performance and appearance states of the used article based on the article information;
calculating a price of the used article corresponding to a selling scheme including an immediate selling and a consignment selling based on the article score;
providing price information including the calculated price to the user terminal;
receiving first selection information about the selling schemes from the user terminal;
transmitting a notification, which instructs the user to deposit a selling price corresponding to the first selection information, to an administrator terminal; and
receiving first confirmation information, which indicates that the selling price corresponding to the first selection information is deposited, from the user terminal.
